(19) United States
(12) Patent Application Publication
(10) Pub. No.: US 2006/0256109 A1
(43) Pub. Date: Nov. 16, 2006

(54) Interactive floorplan viewer

(76) Inventors: Kristin Acker, Seattle, WA (US); Letha Dunn, Kenmore, WA (US); David Beitel, Seattle, WA (US); Garrett McAuliffe, Seattle, WA (US); Lloyd Frink, Seattle, WA (US)

Correspondence Address: PERKINS COIE LLP;PATENT-SEA, P.O. BOX 1247, SEATTLE, WA, 98111-1247, US

(21) Appl. No.: 11/384,009

(22) Filed: Mar. 17, 2006

Related U.S. Application Data
(60) Provisional application No. 60/663,559, filed on Mar. 18, 2005.

(51) Int. Cl. G06T 15/00

(52) U.S. Cl. 345/419

(57) ABSTRACT

A facility for display multimedia artifacts is described. The facility displays a map of a three-dimensional space. The facility further displays a plurality of perspective icons, each in a particular position and orientation relative to the map. When a user selects a displayed perspective icon, the facility displays a media artifact captured from the position and orientation of the selected perspective icon in the three-dimensional space.

### CROSS-REFERENCE TO RELATED APPLICATION

This application claims benefit of U.S. Provisional Application No. 60/663,559, filed Mar. 18, 2005, which is hereby incorporated by reference in its entirety.

### TECHNICAL FIELD

The described technology is directed to the field of computer user interfaces.

### BACKGROUND

The World Wide Web (“the Web”) is a system for publishing information, in which users may use a web browser application to retrieve information, such as web pages, from web servers and display it.

It is common to aggregate a set of digital photos relating to a particular subject on the web for review as a group by a user. For example, web sites maintained by some real estate agents include a web page for each property offered for sale by the agent. In some cases, such pages include a link to a set of digital photos showing different aspects of the property. It is typical for such a set of digital photos to be presented in a slide show, in which the photos are arranged in a particular sequence, and the user selects a “next” button to display each successive photo in the sequence.

This approach to displaying a set of photos showing aspects of a property for sale has significant disadvantages. First, this approach assumes that every user is equally interested in all of the photos, and is indifferent to the order in which he or she views the photos. This is often not the case, in that a particular user may be more interested in some of the photos than others, or may wish to view the photos in a particular order.

Second, it is often difficult for a user who views a sequence of photos of a property to orient him or herself to the context of each of the photos in order to gain a sense of the appearance of the property as a whole.

In view of these disadvantages, a more effective approach to displaying photographs or other media elements relating to a real estate property or other real-world environments would have substantial utility.

### BRIEF DESCRIPTION OF THE DRAWINGS

FIG. 1 is a high-level data flow diagram showing data flow within a typical arrangement of components used to provide the facility.

FIG. 2 is a block diagram showing some of the components typically incorporated in at least some of the computer systems and other devices on which the facility executes.

FIGS. 3 and 4 are flow diagrams showing steps typically performed by the facility in order to present media artifacts in connection with a map.

FIGS. 5-8 are display diagrams showing sample displays generated by the facility.

### DETAILED DESCRIPTION

A software facility for displaying photos of a house, a property, or a space of another type—or other media artifacts relating to the space—based upon a user's interaction with a floorplan or other map (“the facility”) is provided. In some embodiments, the facility displays a floorplan or other map containing a number of “perspective icons,” each of which is at a particular position in the floorplan and facing in a particular direction, corresponding to a photo or other media artifact captured inside a house corresponding to the floorplan from that position and direction. In some embodiments, the perspective items are stylized aerial views of a person facing in a particular direction. When the user activates any of the perspective icons, such as by hovering the mouse pointer over it, the facility displays the media artifact captured from the position and direction of that perspective icon.

In some embodiments, the facility displays a variety of kinds of media artifacts in connection with the map other than still photos. In some embodiments, the map corresponds to various kinds of actual three-dimensional regions, such as property on which a house or other building is situated, a city, a neighborhood, etc. In some embodiments, the facility animates the perspective icons to correspond to changes in perspective reflected in the media artifact. For example, for 360 degree view media artifacts, the facility rotates the perspective icon in place so that it is shown pointing in the same direction as the current direction of the 360 degree view. Similarly, for a walk-through video media artifact, the facility translates and rotates a perspective icon to correspond to translations and rotations of a video camera used to capture the walk-through video. In some embodiments, the facility displays the entire path of a walk-through video media artifact in the context of the map, and permits the user to reposition the perspective icon in the displayed path in order to navigate to the corresponding position in the playback of the walk-through video media artifact, such as by clicking on this point in the displayed path or dragging the perspective icon to this point in the displayed path.

By displaying media artifacts in connection with a map containing perspective icons in some or all of the manners described above, the facility enables a user to navigate between media artifacts in a way that is useful to the user, and enables the user to develop a sense of context for the media artifacts in a way that permits the user to gain a sense of the entire space depicted by the map.

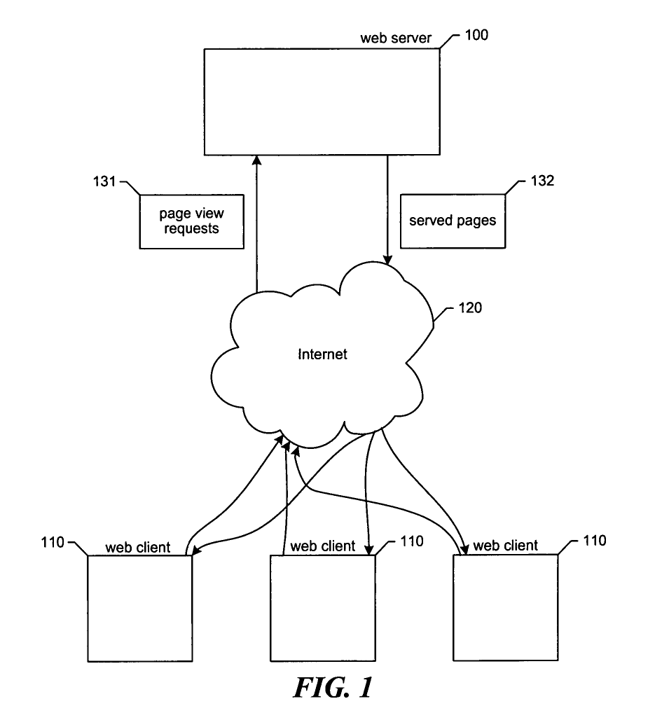

FIG. 1 is a high-level data flow diagram showing data flow within a typical arrangement of components used to provide the facility. A number of web client computer systems 110 that are under user control generate and send page view requests 131 to a logical web server 100 via a network such as the Internet 120. These requests typically include page view requests for pages containing map-driven media artifact displays provided by the facility. Within the web server, these requests may either all be routed to a single web server computer system, or may be loaded-balanced among a number of web server computer systems. The web server typically replies to each with a served page 132.

While various embodiments are described in terms of the environment described above, those skilled in the art will appreciate that the facility may be implemented in a variety of other environments including a single, monolithic computer system, as well as various other combinations of computer systems or similar devices connected in various ways.

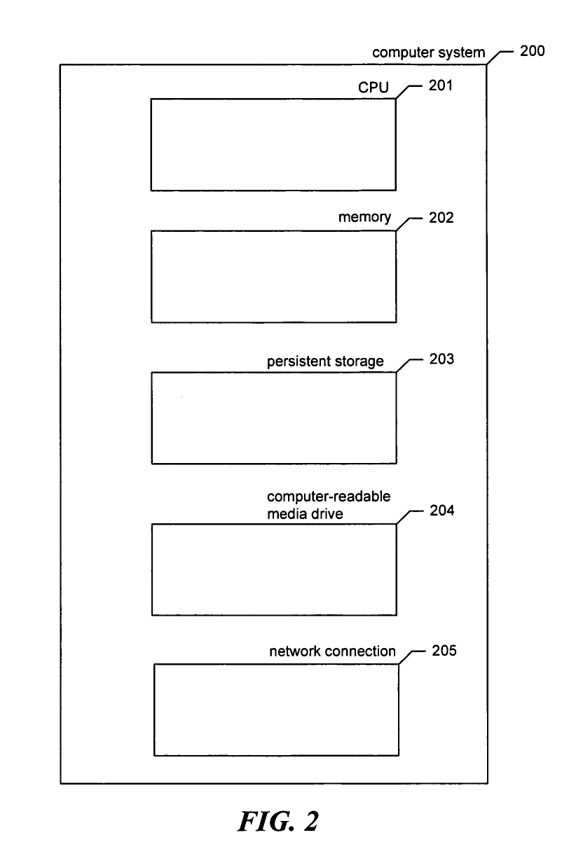

FIG. 2 is a block diagram showing some of the components typically incorporated in at least some of the computer systems and other devices on which the facility executes. These computer systems and devices 200 may include one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable medium; and a network connection 205 for connecting the computer system to other computer systems, such as via the Internet. While computer systems configured as described above are typically used to support the operation of the facility, those skilled in the art will appreciate that the facility may be implemented using devices of various types and configurations, and having various components.

Additional details about the facility's design, implementation, and use follow.

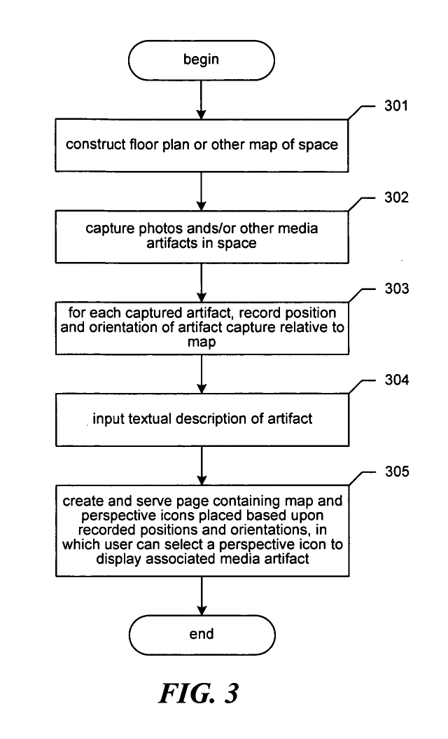

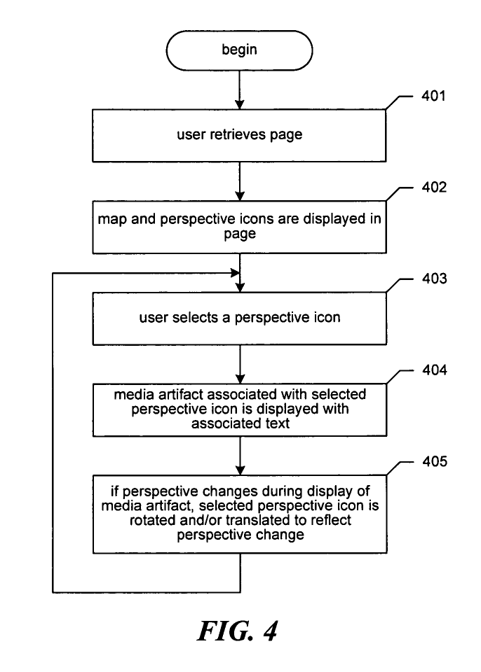

FIGS. 3 and 4 are flow diagrams showing steps typically performed by the facility in order to present media artifacts in connection with a map. FIG. 3 is a flow diagram showing steps typically performed by the facility in order to provide such a display. In step 301, the facility constructs a floorplan or another type of map of the space from which media artifacts are to be captured. Standard image creation/manipulation tools may be used in step 301. In step 302, the facility captures photos and/other media artifacts within the space. A variety of devices may be used for such capture, including still cameras, video cameras, audio recorders, automatically-rotating cameras for capturing 360 degree views, etc. In step 303, the facility records for each artifact captured in step 302 the position and orientation of the artifact capture relative to the map constructed in step 301. The position and orientation may be determined using a variety of approaches, including using a tape measure; using a compass or a protractor; using a GPS receiver or other autolocation system, either integrated into the capture device, coupled to the capture device, or separate from the capture device; performing approximations; etc. In step 304, the facility solicits a textual description of the artifact. The textual description may describe features shown in the artifact, identify a room or other subregion of the map in which the artifact was captured, etc. In some embodiments, the facility stores the constructed floorplan, captured artifacts, recorded positions and orientations, and inputted textual descriptions on a computer file share and/or in a database.

In step 305, the facility creates and serves a web page containing the map, as well as perspective icons placed within the map based upon the recorded positions and orientations. In some embodiments, the facility displays perspective icons having different appearances to visually distinguish media artifacts of different types. When this web page is served, the user can select a perspective icon to display the associated media artifact. In some embodiments, the page is created dynamically in response to a request to serve the page, while in other embodiments the page is created before any requests to serve the page are received.

The page can use a variety of techniques to display the navigation map with perspective icons located in the position and orientation of each captured media artifact. In some embodiments, the facility uses HTML tables or HTML DIVs to perform the layout of the perspective icons. In some embodiments, the facility includes scripting in the page so that when the user hovers the mouse pointer over a particular perspective icon, the media artifact being displayed changes to the media artifact corresponding to the perspective icon being hovered over and the corresponding description text is displayed. In various embodiments, the facility uses different client side browser technologies to perform such scripting, such as Javascript. Using Javascript, the facility captures mouseover events and modifies HTML within the page on the fly. In some embodiments, the facility includes script on the page to handle mouseclick events, which can perform the same or different action mouseover events—for example, they may display a larger copy of the media artifact associated with the selected perspective icon. In some embodiments, rather than including scripting in the page, the facility associates an HTML link with each of the perspective icons, such that when the user clicks on a perspective icon, a new page is retrieved and rendered showing the media artifact and text associated with the selected perspective icon. This may be particularly effective in cases where the user is using a browser that does not support scripting.

In some embodiments, the facility uses SWF (Shockwave file) technology placed in HTML tables or HTML DIVs to perform the layout of the perspective icons. In some embodiments, the facility includes scripting in the page so that when the user hovers the mouse pointer over a particular perspective icon, the media artifact being displayed changes to the media artifact corresponding to the perspective icon being hovered over and the corresponding description text is displayed. In various embodiments, the facility uses different client side browser technologies and their combinations to perform such scripting, such as Javascript and ActionScript. Using ActionScript that is compiled offline into a SWF which is placed on the page, the facility captures mouseover events and modifies the objects inside the SWF on the fly by means of which the media artifact being displayed changes to the media artifact corresponding to the perspective icon being hovered over and the corresponding description text is displayed. In some embodiments, the facility includes Javascript on the page that triggers these actions inside the SWF module. In some embodiments, the facility includes script on the page to handle mouseclick events, which can perform the same or different action mouseover events—for example, they may display a larger copy of the media artifact associated with the selected perspective icon. In some embodiments, rather than including scripting in the page, the facility associates an HTML link with each of the perspective icons, such that when the user clicks on a perspective icon, a new page is retrieved and rendered showing the media artifact and text associated with the selected perspective icon. This may be particularly effective in cases where the user is using a browser that does not support scripting.

After step 305, these steps conclude.

Those skilled in the art will appreciate that the steps shown in FIG. 3 and in each of the flow diagrams discussed below may be altered in a variety of ways. For example, the order of the steps may be rearranged; substeps may be performed in parallel; shown steps may be omitted, or other steps may be included; etc.

FIG. 4 is a flow diagram showing steps typically performed by the facility in order to provide a display to a particular user. In step 401, the user uses a web browser to retrieve the page, such as by following a link for a particular property or a page associated with a particular property that is devoted to the presentation of media artifacts captured from that property. In step 402, the browser renders the retrieved page so that the map and perspective icons are displayed. In step 403, the user selects a perspective icon, such as by hovering the mouse pointer over the selected perspective icon, or clicking the-mouse button while-the-mouse-pointer points to the selected perspective icon. In some embodiments, the facility modifies the display of the selected perspective icon to visually distinguish it from the other displayed perspective icons, such as by making it larger or displaying it in a different color. In step 404, the media artifact associated with the perspective icon selected in step 403 is displayed as part of the page, along with any associated text. The particulars of such display vary based upon the type of the media artifact. For example, a still image is typically persistently displayed; a time-sequenced media sequence such as a video clip, audio clip, or a 360 degree view is rendered throughout its time sequence, beginning at the time the user selects the perspective icon. In step 405, if the perspective of the media artifact changes during its display, such as when a camera capturing a walk-through video is moved, the selected perspective icon is rotated and/or translated to reflect this change in perspective. After step 405, the facility continues in step 403 to permit the user to select a different perspective icon.

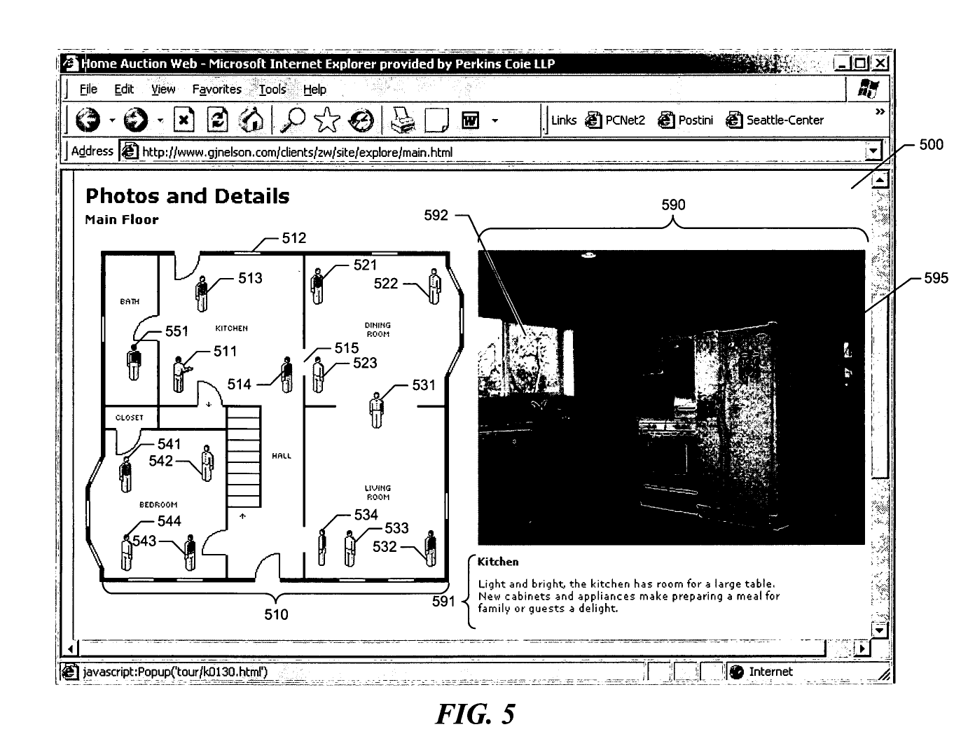

FIGS. 5-8 are display diagrams showing sample displays generated by the facility. FIG. 5 shows a first display 500 produced by the facility in connection with a floorplan of a house. Display 500 is in particular associated with a particular floor of the house; in some embodiments, the facility provides controls for navigating from this floor of the house to other floors, to the grounds or outbuildings surrounding the house. etc. (not shown). The display contains a floorplan map 510, which shows a number of rooms, doors, windows, stairways, hallways, etc. on the main floor of the house. In some embodiments, the floorplan contains distance and/or area measurements for walls, rooms, etc.; colors showing the color of walls, flooring, ceiling, etc.; and/or other attributes of the floor and/or rooms (not shown).

Within the map, the facility displays a number of perspective icons, such as perspective icons 511, 513, and 514 in the kitchen. By mousing over or clicking on perspective icon 511, the user selects it. In response, the facility displays photo media artifact 590, which was captured from the position of and in the direction indicated by selected perspective icon 511. It can be seen that details such as flooring, lighting, cabinets, cover tops, appliances, and wall and ceiling color are visible in the photo artifact. It can also be seen that details 592 beyond window 512 are visible, as are details 595 behind doorway 515. Also in response to the user's selection of perspective icon 511, the facility displays description 591. In some embodiments, this description is associated uniquely with this media artifact, while in others, the description is associated with all of the media artifacts captured in the same room, or a particular other subregion of the map.

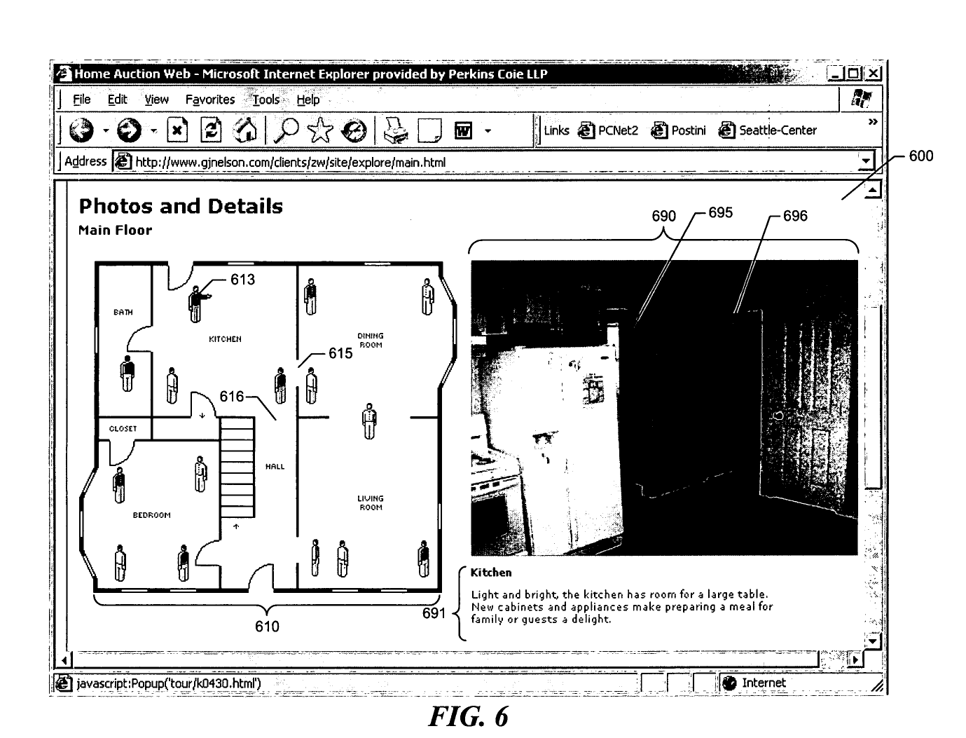

Once a particular perspective icon is selected and the corresponding media artifact is displayed, the user can select a different perspective icon to display the corresponding different media artifact. FIG. 6 shows a second display 600 displayed by the facility in response to the user's selection of perspective icon 513 shown in FIG. 5. It can be seen that, in response to the selection of perspective icon 513 (shown as perspective icon 613 in FIG. 6) the facility has displayed media artifact 690 corresponding to perspective icon 613. It can be seen that this perspective icon shows visual details 695 beyond doorway 615 and visual details 696 beyond doorway 616. By observing the relative perspectives for the displayed two photos, users are able to “stitch together” a mental impression of the entire kitchen.

In some embodiments, the facility provides an additional “play” control (not shown) that the user can activate in order to automatically cycle through the available media artifacts in a predetermined order. As the facility displays each new media artifact, it visually highlights the corresponding perspective icon to enable the user to associate the media artifact with the position and orientation at which it was captured.

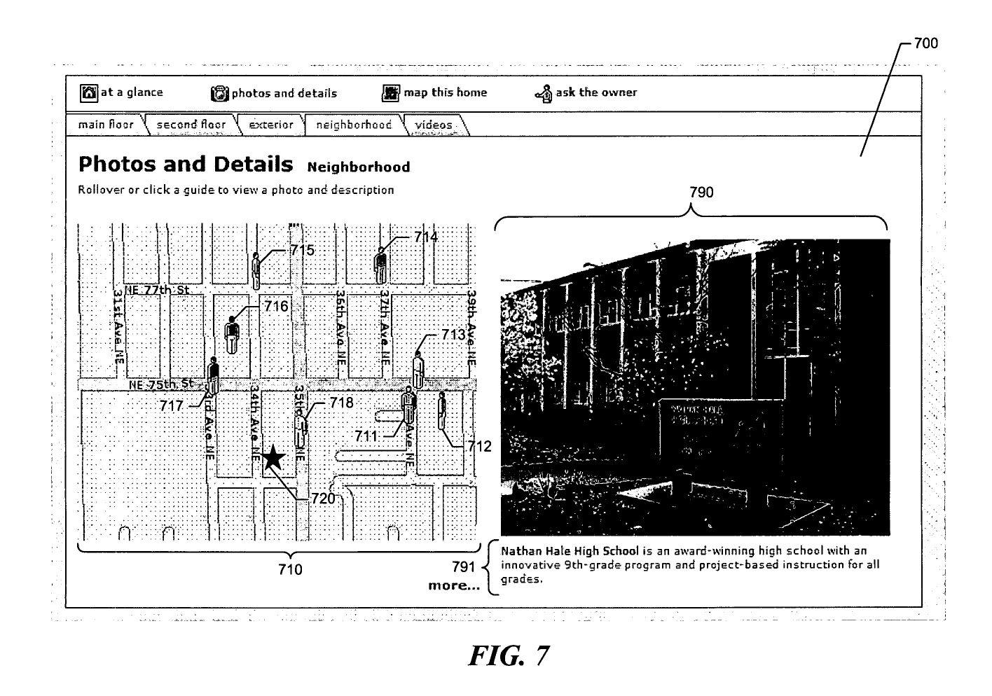

As mentioned above, the facility may display media artifacts with respect to maps of other kinds of spaces, such as cities or neighborhoods. FIG. 7 shows a display 800 of a media artifact with respect to a map of a neighborhood. A map 710 shows a neighborhood surrounding the location 720 of a house for sale. Displayed within the map are perspective icons 711-718 at various positions and orientations. The map further shows additional landmarks or location guides, such as street names and locations.

The user has selected perspective icon 711, causing the facility to display a photo media artifact 790 associated with perspective icon 711. Additionally, the facility has displayed description 791 associated with perspective icon 711. The user may select other perspective icons displayed in the map in order to display other media artifacts associated with those icons.

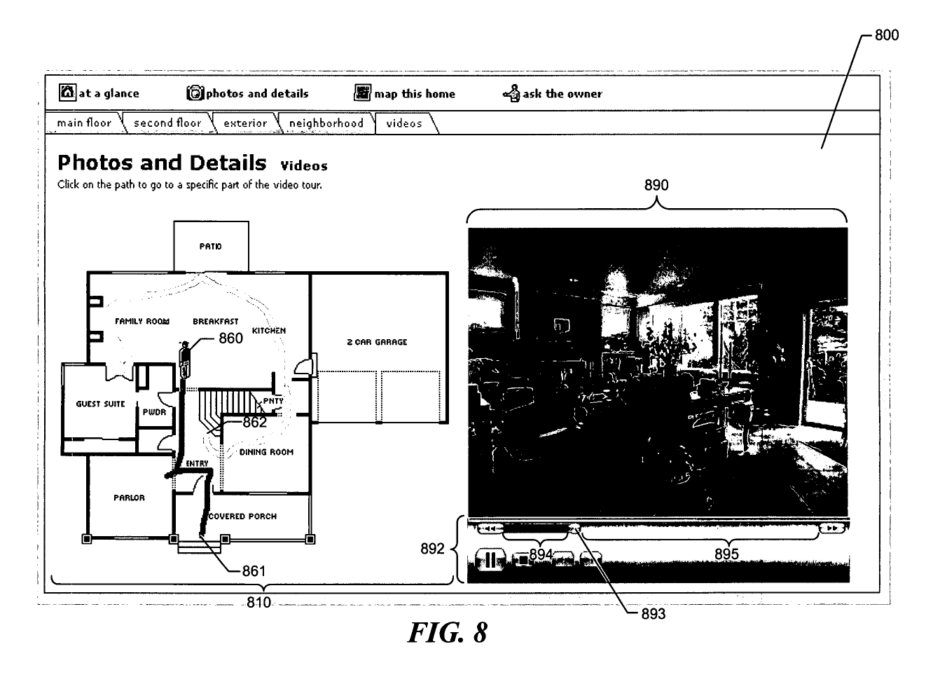

FIG. 8 shows a display in which the path of a walk-through video artifact is displayed within a house floorplan. The display 800 includes a floorplan map 810 as well as a media player 890 in which the walk-through video media artifact is rendered, including well-known media player controls 892. Displayed within the floorplan map is a path traversed by a video capture device such as a video camera to create the walk-through video media artifact. The path has a starting point 861, and an ending point 862. A perspective icon 860 is located at a point in the path corresponding to the current position in the playback of the walk-through video media artifact. The perspective icon 860 is further oriented in a direction corresponding to the direction in which the video capture device was oriented at the current playback position. In some embodiments, the facility displays the portion of the path up to the perspective icon in a first color, such as a color similar to that of the media player's progress bar 894, and the remainder of the path in a different color, such as a lighter shade of the same hue. The user may choose a new position in the playback of the walk-through media artifact by relocating the perspective icon to a different point on the path, such as dragging the perspective icon to the new point, or clicking on the new point. In response, the facility repositions the playback of the walk-through video media artifact in the media player to the corresponding position. In some embodiments, the facility may instead use controls of the media player to reposition the playback, such as by dragging slider 893 to a new position in range 894 or range 895. In response, the facility relocates the perspective icon to the corresponding point on the path. Also, as described above, in some embodiments, during the playback of the walk-through video media artifact, the facility may translate and/or rotate the perspective icon along the path to correspond to changes in position or orientation that occur in the capture of the walk-through video media artifact.

The facility may be used to display walk-through video media artifacts in connection with a wide variety of maps, including displaying walk-through video media artifacts of a yard in connection with a map of the grounds, or a walk-through video media artifact of a neighborhood in connection with a neighborhood street map.

It will be appreciated by those skilled in the art that the above-described facility may be straightforwardly adapted or extended in various ways. For example, the facility may be used to display a wide variety of types of media artifacts, in connection with maps of a wide variety of styles depicting a wide variety of types of spaces. While the foregoing description makes reference to particular embodiments, the scope of the invention is defined solely by the claims that follow and the elements recited therein.

I/We claim:

1. One or more generated data signals collectively conveying a display page data structure, comprising:
information specifying the display of a spatial map of a 3-dimensional space;
information specifying the display of a plurality of perspective icons, each at a particular position and orientation relative to the map; and
information specifying the display, when a user selects a displayed perspective icon, of a media artifact captured from the position and orientation of the selected perspective icon in the 3-dimensional space.

2. The data signals of claim 1 wherein the spatial map is of a house.

3. The data signals of claim 1 wherein the spatial map is of a portion of a house.

4. The data signals of claim 1 wherein the spatial map is of a floor of a house.

5. The data signals of claim 1 wherein the spatial map is of grounds surrounding a house.

6. The data signals of claim 1 wherein the displayed media artifact is a still image.

7. The data signals of claim 1 wherein the displayed media artifact is a video sequence.

8. The data signals of claim 1 wherein the displayed media artifact is a 360 degree view.

9. The data signals of claim 1 wherein the displayed media artifact is an audio clip.

10. The data signals of claim 1 wherein the display page data structure further comprises information specifying the display, when a user selects a displayed perspective icons, of a textual description associated with the selected perspective icon.

11. The data signals of claim 1 wherein the information specifying the display, when a user selects a displayed perspective icon, of a media artifact captured from the position and orientation of the selected perspective icon specifies such display when a user selects a displayed perspective icon by clicking on the selected displayed perspective icon.

12. The data signals of claim 1 wherein the information specifying the display, when a user selects a displayed perspective icon, of a media artifact captured from the position and orientation of the selected perspective icon specifies such display when a user selects a displayed perspective icon by holding a mouse pointer over the selected displayed perspective icon.

13. The data signals of claim 1 wherein the displayed media artifact is a time-sequenced multimedia artifact.

14. The data signals of claim 13 wherein the display page data structure further comprises information specifying the animation of the displayed perspective icon to correspond to changes in capture position or orientation during the display of the media artifact.

15. The data signals of claim 14 wherein displayed media artifact is a 360 degree view.

16. The data signals of claim 14 wherein displayed media artifact is a video walkthrough.

17. One or more computer memories collectively storing a display page data structure, comprising:
information specifying the display of a spatial map of a 3-dimensional space;
information specifying the display of a plurality of perspective icons, each at a particular position and orientation relative to the map; and
information specifying the display, when a user selects a displayed perspective icon, of a media artifact captured from the position and orientation of the selected perspective icon in the 3-dimensional space.

18. A method in a computing system for displaying multimedia artifacts, comprising:
displaying a map of a 3-dimensional space;
displaying a plurality of perspective icons, each at a particular position and orientation relative to the map; and
when a user selects a displayed perspective icon, displaying a media artifact captured from the position and orientation of the selected perspective icon in the 3-dimensional space.

19. The method of claim 18, further comprising:
displaying an activatable control; and
when the user selects the activatable control, for each of the displayed perspective icons in turn:
visually emphasizing the perspective icon; and
displaying the media artifact captured from the position and orientation from a perspective icon in the 3-dimensional space.

20. A computer-readable medium whose contents cause a computing system to perform a method in a computing system for displaying multimedia artifacts, the method comprising:
displaying a map of a 3-dimensional space;
displaying a plurality of perspective icons, each at a particular position and orientation relative to the map; and
when a user selects a displayed perspective icon, displaying a media artifact captured from the position and orientation of the selected perspective icon in the 3-dimensional space.

21. A computing system for displaying multimedia artifacts, comprising:
a display device that displays a map of a 3-dimensional space and a plurality of perspective icons, each perspective icon at a particular position and orientation-relative to the map;
an input device usable by a user to select a perspective icon display device; and
a display device control system that causes the display device to display a media artifact captured from the position and orientation in the 3-dimensional space of the perspective icon selected using the input device.

22. A method in a computing system for displaying a walk-through video, comprising:
displaying a building floorplan;
displaying within the floorplan a path through the building traversed in order to capture the walk-through video;
rendering the walk-through video simultaneously with displaying the floorplan; and
moving a perspective icon along the path in a position that is synchronized with the point in the path from which the current point in the walk-through video playback was captured.

23. The method of claim 22 wherein moving the perspective icon includes relocating the perspective icon to a different point on the path.

24. The method of claim 22 wherein moving the perspective icon includes rotating the perspective icon to a new orientation.

25. The method of claim 22, further comprising:
receiving user input relocating the perspective icon to a new point in the displayed path; and
in response to the user input, repositioning the playback of the walk-through video to a position in the walk-through video corresponding to the new point in the displayed path.

26. The method of claim 22 wherein the playback of the video walk-through is performed using a media player, the method further comprising:
receiving user input constituting a manipulation of controls provided by the media player to reposition the playback of the video walk-through to a new position; and
in response to the user input, moving the perspective icon to a point in the displayed path corresponding to the new location in the walk-through video playback.

27. A computer-readable medium whose contents cause a computing system to perform a method for displaying a video artifact, the method comprising:
displaying a map of a 3-dimensional space;
displaying within the map a path through the space traversed in order to capture the video artifact;
rendering the video artifact simultaneously with displaying the map; and
moving a perspective icon along the path in a position that is synchronized with the point on the path from which the current point in rendering of the video artifact was captured.

28. The computer-readable medium of claim 27 wherein moving the perspective icon includes relocating the perspective icon to a different point on the path.

29. The computer-readable medium of claim 27 wherein moving the perspective icon includes rotating the perspective icon to a new orientation.

30. The computer-readable medium of claim 27, the method further comprising:
receiving user input relocating the perspective icon to a new point in the displayed path; and
in response to the user input, repositioning the rendering of the walk-through video to a position in the walk-through video corresponding to the new point in the displayed path.

31. The computer-readable medium of claim 27 wherein the playback of the video walk-through is performed using a media player, the method further comprising:
receiving user input constituting a manipulation of controls provided by the media player to reposition the rendering of the video artifact to a new position; and
in response to the user input, moving the perspective icon to a point in the displayed path corresponding to the new location in the rendering of the video artifact.

32. The computer-readable medium of claim 27 wherein 3-dimensional space is a floor of a building.

33. The computer-readable medium of claim 27 wherein 3-dimensional space is an outdoor area.
